(19) United States
(12) Patent Application Publication
(10) Pub. No.: US 2023/0292302 A1
(43) Pub. Date: Sep. 14, 2023

(54) SEMI-PERSISTENT TRANSMISSION BASED CHANNEL STATISTICS REPORTING

(71) Applicant: QUALCOMM Incorporated, San Diego, CA (US)

(72) Inventors: Yan ZHOU, San Diego, CA (US); Hamed PEZESHKI, San Diego, CA (US); Konstantinos DIMOU, New York, NY (US); Tao LUO, San Diego, CA (US)

(21) Appl. No.: 18/002,771

(22) PCT Filed: Aug. 27, 2021
(86) PCT No.: PCT/US2021/047926

§ 371 Date: Dec. 21, 2022

(30) Foreign Application Priority Data
Sep. 4, 2020 (GR) 20200100541

(51) Int. Cl. H04W 72/11; H04W 24/10; H04W 72/541; H04W 72/23

(52) U.S. Cl. CPC H04W 72/11; H04W 24/10; H04W 72/541; H04W 72/23

(57) ABSTRACT

Various aspects of the present disclosure generally relate to wireless communication. In some aspects, a user equipment (UE) may receive, from a base station, one or more semi-persistent communications. The UE may transmit, to the base station, a channel statistics report indicating one or more channel statistics associated with a channel measurement parameter based at least in part on the one or more semi-persistent communications. Numerous other aspects are provided.

### CROSS-REFERENCE TO RELATED APPLICATION

This patent application claims priority to Greek Patent Application No. 20200100541, filed on Sep. 4, 2020, entitled “SEMI-PERSISTENT TRANSMISSION BASED CHANNEL STATISTICS REPORTING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for semi-persistent transmission based channel statistics reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, one or more semi-persistent communications; and transmitting, to the base station, a channel statistics report indicating one or more channel statistics associated with a channel measurement parameter based at least in part on the one or more semi-persistent communications.

In some aspects, a method of wireless communication performed by a base station includes transmitting, to a UE, one or more semi-persistent communications; and receiving, from the UE, a channel statistics report indicating one or more channel statistics that are based at least in part on a channel measurement parameter associated with the one or more semi-persistent communications.

In some aspects, a UE for wireless communication includes a memory and one or more processors, coupled to the memory, configured to: receive, from a base station, one or more semi-persistent communications; and transmit, to the base station, a channel statistics report indicating one or more channel statistics associated with a channel measurement parameter based at least in part on the one or more semi-persistent communications.

In some aspects, a base station for wireless communication includes a memory and one or more processors, coupled to the memory, configured to: transmit, to a UE, one or more semi-persistent communications; and receive, from the UE, a channel statistics report indicating one or more channel statistics that are based at least in part on a channel measurement parameter associated with the one or more semi-persistent communications.

In some aspects, a non-transitory computer-readable medium storing a set of instructions for wireless communication includes one or more instructions that, when executed by one or more processors of a UE, cause the UE to: receive, from a base station, one or more semi-persistent communications; and transmit, to the base station, a channel statistics report indicating one or more channel statistics associated with a channel measurement parameter based at least in part on the one or more semi-persistent communications.

In some aspects, a non-transitory computer-readable medium storing a set of instructions for wireless communication includes one or more instructions that, when executed by one or more processors of a base station, cause the base station to: transmit, to a UE, one or more semi-persistent communications; and receive, from the UE, a channel statistics report indicating one or more channel statistics that are based at least in part on a channel measurement parameter associated with the one or more semi-persistent communications.

In some aspects, an apparatus for wireless communication includes means for receiving, from a base station, one or more semi-persistent communications; and means for transmitting, to the base station, a channel statistics report indicating one or more channel statistics associated with a channel measurement parameter based at least in part on the one or more semi-persistent communications.

In some aspects, an apparatus for wireless communication includes means for transmitting, to a UE, one or more semi-persistent communications; and means for receiving, from the UE, a channel statistics report indicating one or more channel statistics that are based at least in part on a channel measurement parameter associated with the one or more semi-persistent communications.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of downlink control information (DCI) that schedules multiple communications, in accordance with the present disclosure.

FIG. 4 is a diagram illustrating an example of an industrial Internet-of-Things (IIoT) communication network, in accordance with the present disclosure.

FIG. 5 is a diagram illustrating an example of an IIoT communication on the IIoT communication network of FIG. 4, in accordance with the present disclosure.

FIG. 6 is a diagram illustrating an example associated with semi-persistent transmission based channel statistics reporting, in accordance with the present disclosure.

FIGS. 7 and 8 are diagrams illustrating example processes associated with semi-persistent transmission based channel statistics reporting, in accordance with the present disclosure.

FIGS. 9 and 10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

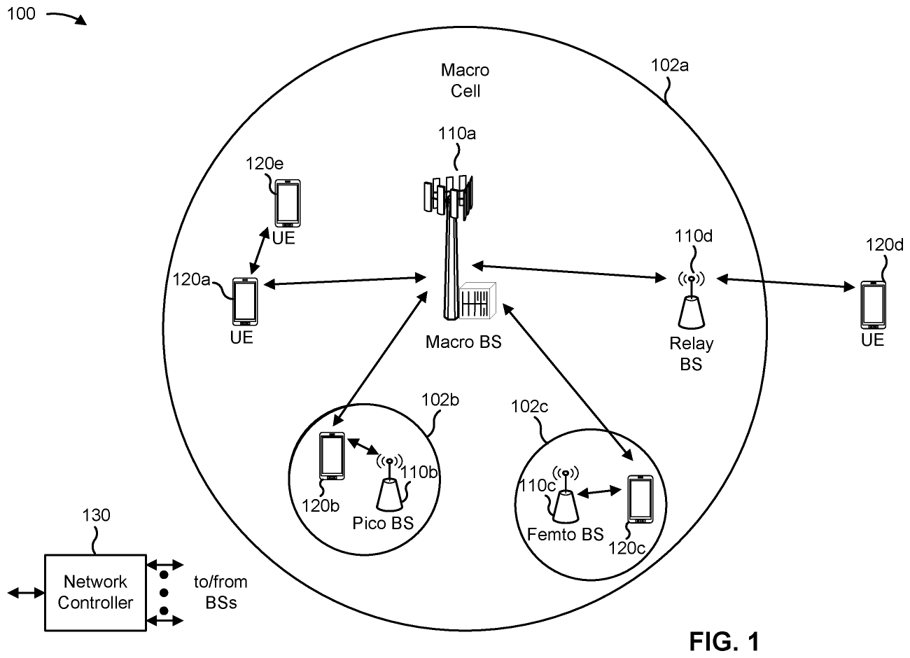

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

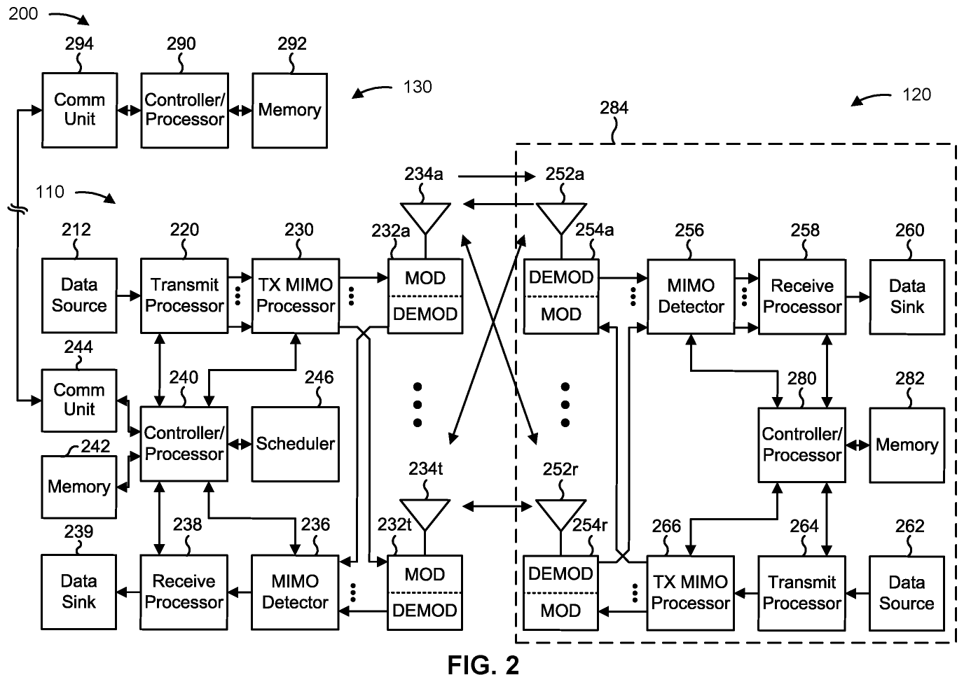

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

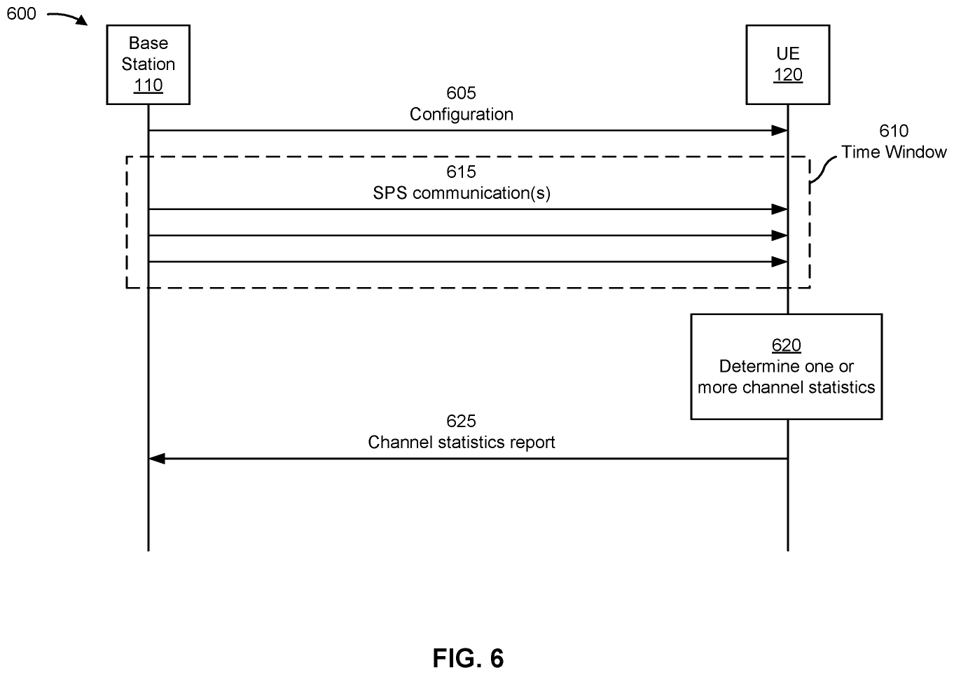

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 6-10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 6-10).

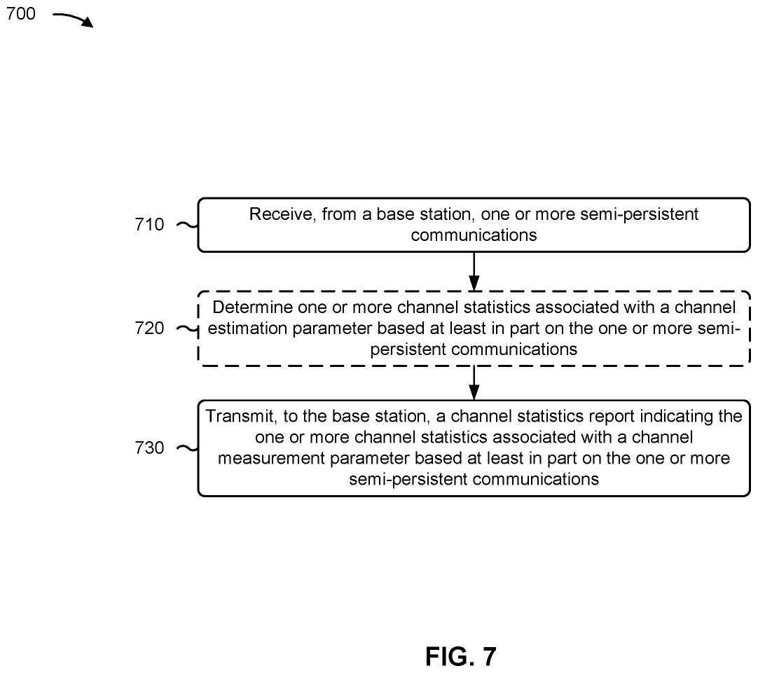

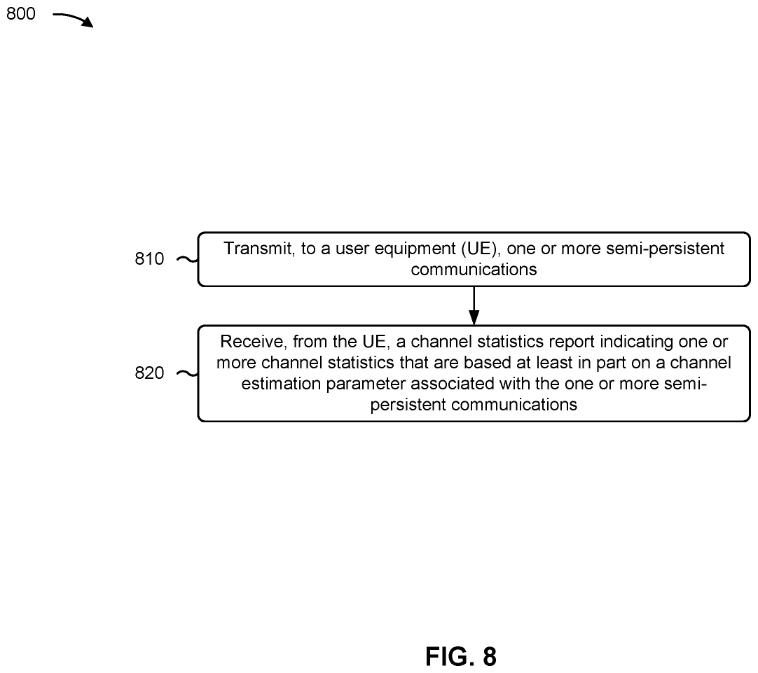

Controller/processor 240 of base station 110, controller/processor 280 of UE 120, and/or any other component(s) of FIG. 2 may perform one or more techniques associated with semi-persistent transmission based channel statistics reporting, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, the UE 120 includes means for receiving, from a base station, one or more semi-persistent communications; means for determining one or more channel statistics associated with a channel measurement parameter based at least in part on the one or more semi-persistent communications; and/or means for transmitting, to the base station, a channel statistics report indicating the one or more channel statistics associated with a channel measurement parameter based at least in part on the one or more semi-persistent communications. The means for the UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, the UE 120 includes means for measuring the one or more semi-persistent communications to determine one or more values of the channel measurement parameter; and/or means for determining the one or more channel statistics based at least in part on the one or more values of the channel measurement parameter. In some aspects, the UE 120 includes means for measuring, for a semi-persistent communication of the one or more semi-persistent communications, a DMRS associated with the semi-persistent communication, to determine a value of the channel measurement parameter. In some aspects, the UE 120 includes means for measuring a semi-persistent communication of the one or more semi-persistent communications using decoded data associated with the semi-persistent communication.

In some aspects, the UE 120 includes means for receiving, during a semi-persistent scheduling (SPS) occasion, a plurality of repetitions of a semi-persistent communication of the one or more semi-persistent communications. In some aspects, the UE 120 includes means for determining one or more channel statistics per repetition of the one or more semi-persistent communications. In some aspects, the UE 120 includes means for receiving the plurality of repetitions in different symbols, means for receiving the plurality of repetitions in different subbands, or means for receiving the plurality of repetitions on different beams.

In some aspects, the UE 120 includes means for transmitting, using a periodic uplink resource, the channel statistics report, means for transmitting, using a semi-persistent uplink resource, the channel statistics report, or means for transmitting, using an aperiodic uplink resource, the channel statistics report.

In some aspects, the UE 120 includes means for receiving, from the base station, a configuration associated with reporting channel statistics.

In some aspects, the UE 120 includes means for measuring, during a time window, the one or more semi-persistent communications to determine one or more values of the channel measurement parameter; and/or means for determining the one or more channel statistics based at least in part on the one or more values of the channel measurement parameter. In some aspects, the UE 120 includes means for transmitting, to the base station at a reporting time, the channel statistics report using the uplink resource.

In some aspects, the UE 120 includes means for receiving, from the base station via medium access control (MAC) control element (MAC-CE) signaling or downlink control information (DCI) signaling, an activation message or a deactivation message associated with the channel statistics report. In some aspects, the UE 120 includes means for receiving DCI triggering the channel statistics report.

In some aspects, the UE 120 includes means for determining the one or more channel statistics associated with the channel measurement parameter based at least in part on one or more measurements performed during a previous time window, for performing measurements of the one or more semi-persistent communications, before the DCI is received.

In some aspects, the UE 120 includes means for determining one or more channel statistics associated with the channel measurement parameter based at least in part on one or more measurements performed before the end of a last semi-persistent scheduling occasion before a reporting time associated with transmitting the channel statistics report.

In some aspects, the UE 120 includes means for transmitting, to the base station at a reporting time, the channel statistics report using the uplink resource. In some aspects, the UE 120 includes means for receiving a plurality of SPS configurations. In some aspects, the UE 120 includes means for receiving a configuration associated with reporting channel statistics.

In some aspects, the UE 120 includes means for transmitting channel statistics reports per SPS configuration. In some aspects, the UE 120 includes means for transmitting a channel statistics report indicating one or more channel statistics of semi-persistent communications across all SPS configurations or across the subset of SPS configurations. In some aspects, the UE 120 includes means for receiving, via MAC-CE signaling or DCI signaling, an update to the configuration associated with reporting channel statistics.

In some aspects, the base station 110 includes means for transmitting, to a UE, one or more semi-persistent communications; and/or means for receiving, from the UE, a channel statistics report indicating one or more channel statistics that are based at least in part on a channel measurement parameter associated with the one or more semi-persistent communications. The means for the base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, the base station 110 includes means for transmitting, during an SPS occasion, a plurality of repetitions of a semi-persistent communication of the one or more semi-persistent communications. In some aspects, the base station 110 includes means for receiving channel statistics reports per repetition of the one or more semi-persistent communication. In some aspects, the base station 110 includes means for transmitting the plurality of repetitions in different symbols, means for transmitting the plurality of repetitions in different subbands, or means for transmitting the plurality of repetitions on different beams.

In some aspects, the base station 110 includes means for receiving, in a periodic uplink resource, the channel statistics report, means for receiving, in a semi-persistent uplink resource, the channel statistics report, or means for receiving, in an aperiodic uplink resource, the channel statistics report.

In some aspects, the base station 110 includes means for transmitting, to the UE, a configuration associated with reporting channel statistics. In some aspects, the base station 110 includes means for receiving, from the UE at a reporting time, the channel statistics report in the uplink resource.

In some aspects, the base station 110 includes means for transmitting, to the UE via MAC-CE signaling or DCI signaling, an activation message or deactivation message associated with the channel statistics report. In some aspects, the base station 110 includes means for transmitting, to the UE, DCI triggering the channel statistics report.

In some aspects, the base station 110 includes means for receiving, from the UE at a reporting time, the channel statistics report in the uplink resource. In some aspects, the base station 110 includes means for transmitting, to the UE, a plurality of SPS configurations. In some aspects, the base station 110 includes means for transmitting, to the UE, a configuration associated with reporting channel statistics. In some aspects, the base station 110 includes means for receiving channel statistics reports per SPS configuration.

In some aspects, the base station 110 includes means for receiving a channel statistics report indicating one or more channel statistics of semi-persistent communications across all SPS configurations or across the subset of SPS configurations. In some aspects, the base station 110 includes means for transmitting, via MAC-CE signaling or DCI signaling, an update to the configuration associated with reporting channel statistics.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

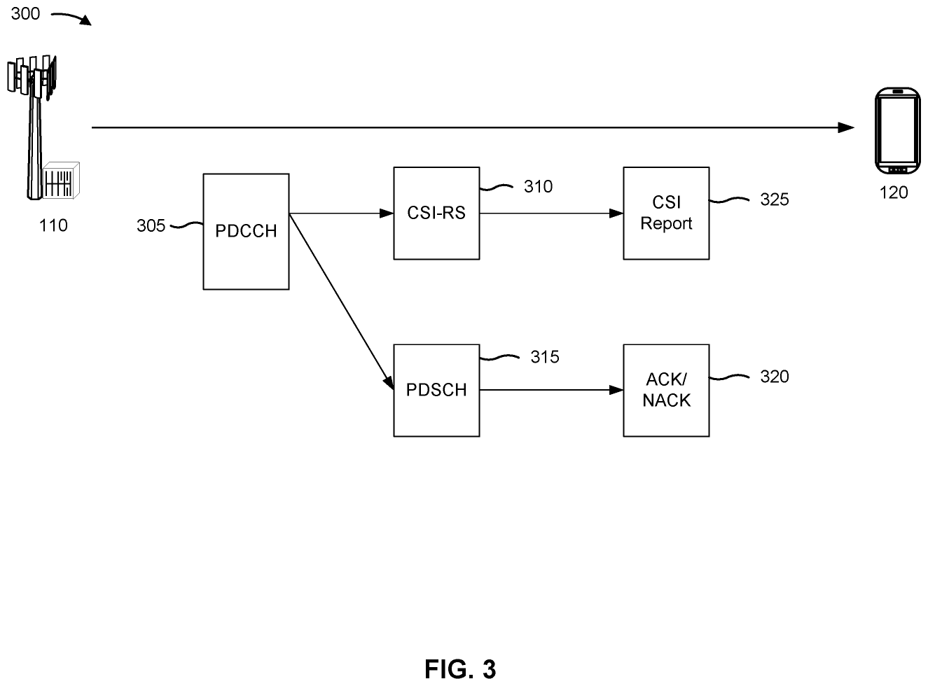

FIG. 3 is a diagram illustrating an example 300 of DCI that schedules multiple communications, in accordance with the present disclosure. As shown in FIG. 3, a base station 110 and a UE 120 may communicate with one another. In some aspects, the base station 110 and the UE 120 may be included in a wireless network, such as wireless network 100. The base station 110 and the UE 120 may communicate on a wireless access link, which may include an uplink and a downlink.

The base station 110 may transmit, to the UE 120, a physical downlink control channel (PDCCH) communication 305 that includes DCI. The DCI may schedule multiple communications for the UE 120. For example, the DCI may schedule a transmission of a channel state information (CSI) reference signal (CSI-RS) 310. The CSI-RS 310 may be an aperiodic CSI-RS in that the CSI-RS 310 is dynamically triggered by the DCI in PDCCH communication 305. In some aspects, the CSI-RS 310 may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel measurement parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, and/or a refined downlink beam (e.g., using a beam refinement procedure or a beam management procedure), among other examples.

The DCI included in PDCCH communication 305 may also schedule a data communication, such as physical downlink shared channel (PDSCH) communication 315. The PDSCH communication 315 may be a dynamic grant PDSCH communication in that it is triggered or scheduled by the DCI included in the PDCCH communication 305.

In example 300, the DCI included in the PDCCH communication 305 may also indicate scheduling information for uplink communications to be transmitted by the UE 120. The scheduling information may indicate a resource to be used for acknowledgement (ACK) or negative acknowledgement (NACK) feedback (e.g., ACK/NACK feedback or ACK/NACK information) associated with a communication scheduled by the DCI. For example, the scheduling information may indicate one or more uplink resources for ACK/NACK feedback 320 that is associated with the PDSCH communication 315. The one or more uplink resources for ACK/NACK feedback 320 may be uplink control resources (e.g., one or more physical uplink control channel (PUCCH) resources and/or the like). For example, the ACK/NACK feedback 320 may be indicated in uplink control information (UCI) carried on a PUCCH resource.

In some aspects, the scheduling information in the DCI may indicate one or more uplink resources for a CSI report 325. The CSI report 325 may indicate one or more channel measurement parameters, described above, to the base station 110. In some aspects, the one or more uplink resources for the CSI report 325 may be the same as the one or more uplink resources for ACK/NACK feedback 320 (e.g., both the ACK/NACK feedback 320 and the CSI report 325 may be included in the same uplink resources). In some aspects, the one or more uplink resources for the CSI report 325 may be different than the one or more uplink resources for ACK/NACK feedback 320 (e.g., the ACK/NACK feedback 320 may be transmitted using a PUCCH resource and the CSI report may be transmitted using a physical uplink shared channel (PUSCH) resource or a different PUCCH resource).

In some cases, scheduling information in the DCI may be indicated once and reused for multiple communications. For example, the DCI may schedule multiple semi-persistent or periodic downlink communications. The scheduling information may indicate uplink resource(s) for the ACK/NACK feedback 320 for the semi-persistent or periodic downlink communications. The UE 120 may reuse the scheduling information for the ACK/NACK feedback 320 at each instance of the semi-persistent or periodic downlink communications. Similarly, the UE 120 may reuse scheduling information associated with the CSI report 325 for future CSI reports. In this way, the base station 110 and the UE 120 may conserve signaling overhead associated with scheduling the communications.

As indicated above, FIG. 3 is provided as an example. Other examples may differ from what is described with respect to FIG. 3.

Industrial IoT (IIoT) is a branch of cellular technology in which UEs and base stations may be used to carry control data, measurement data, and/or the like between various industrial systems. For example, IIoT may be used to control IIoT devices such as sensors and/or actuators, to exchange measurement information between other IIoT devices such as programmable logic controllers (PLCs) of a factory floor (for example, in a factory automation application), among other examples. According to various aspects, IIoT devices discussed herein (e.g., sensors, actuators, PLCs, and/or the like) may be, may include, or may be included in, UEs such as UE 120 discussed above in connection with FIG. 1. In some aspects, an IIoT device may function as a small cell (e.g., a pico cell, a femto cell, and/or the like), in which case the IIoT device may be, include, or be included in, a base station such as the base station 110 discussed above in connection with FIG. 1.

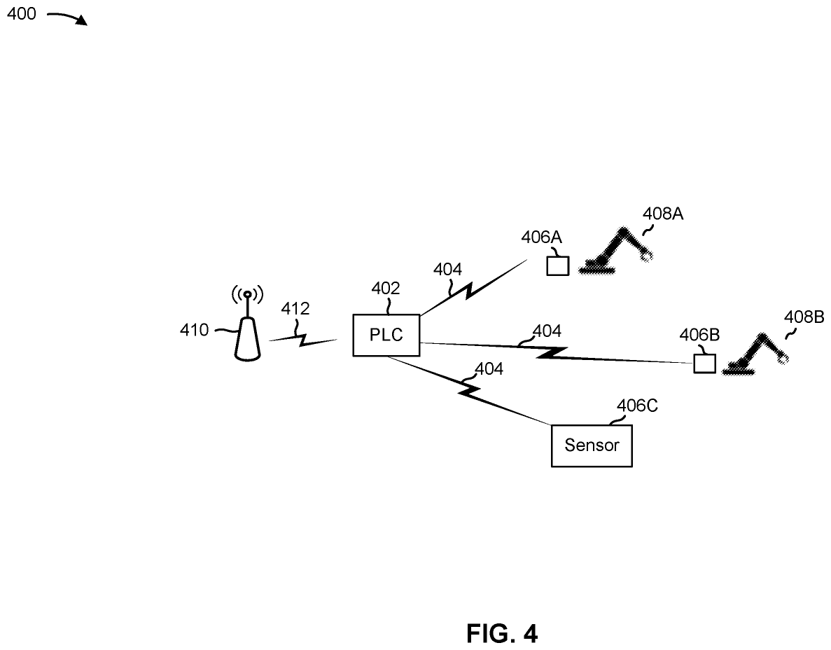

FIG. 4 is a diagram illustrating an example of an IIoT communication network 400, in accordance with the present disclosure.

As shown, the IIoT communication network 400 includes a PLC 402 (which is, itself, a type of IIoT device) that exchanges wireless communication 404 with IIoT devices 406 (shown as 406A, 406B, and 406C). The IIoT devices 406 may include actuators 406A and 406B, sensors 406C, other PLCs (not shown), and/or the like. In some aspects, the IIoT devices 406 may be associated with industrial equipment 408 (such as industrial equipment 408A and 408B). The IIoT communication network 400 may include a base station 410 that exchanges communications 412 with the PLC 402 and/or communications 412 with one or more of the other IIoT devices 406.

The communications between the PLC 402 and IIoT devices 406 may include cyclic exchanges of information. The PLC 402 may provide commands in wireless signals to control industrial equipment 408A and 408B. Actuators 406A, 406B and sensors 406C may be separate from the industrial equipment 408A and 408B, and/or industrial equipment 408A and 408B may comprise actuators 406A, 406B, sensors 406C, and/or the like. The PLC 402 may automate control of varied manufacturing processes, machines, and control systems (e.g., of industrial electromechanical processes and devices (such as control of machinery on factory assembly lines, robotic devices, amusement rides, light fixtures), and/or chemical processes (such as polymer, pharmaceutical, food, and some beverage production facilities, power plants, oil refineries or other refineries, natural gas processing and biochemical plants, water and wastewater treatment, and/or pollution control equipment), among other examples). An IIoT communication network 400 may include any number of PLCs 402, sensors and actuators 406A, 406B, industrial equipment 408A, 408B, and/or the like used to perform an industrial objective.

As indicated above, FIG. 4 is provided as an example. Other examples may differ from what is described with respect to FIG. 4.

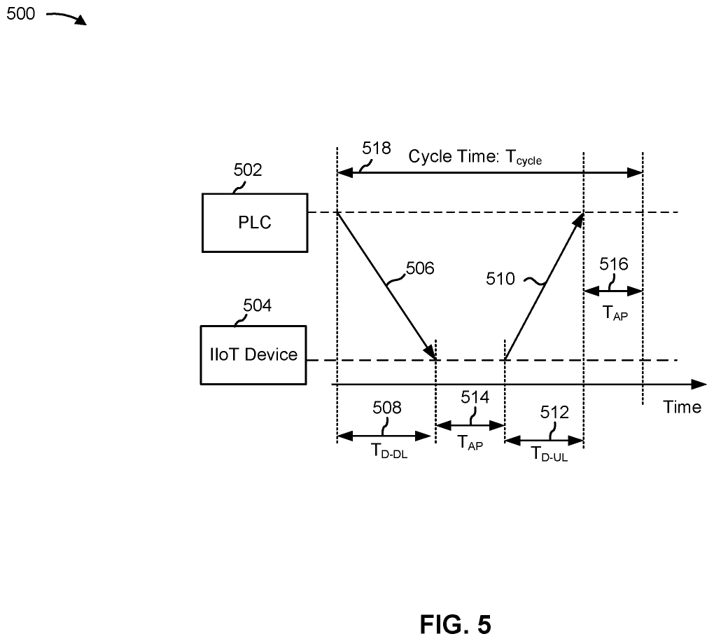

FIG. 5 is a diagram illustrating an example 500 of an IIoT communication on the IIoT communication network 400 of FIG. 4, in accordance with the present disclosure.

As shown, a PLC 502 and an IIoT device 504 may exchange periodic traffic. In some aspects, the IIoT device 504 may be, be similar to, include, or be included in the IIoT devices shown in FIG. 4. The PLC 502 may transmit a communication 506 such as a command or other communication to the IIoT device 504 during a period of time T_{D-DL}, 508. The communication 508 from the PLC 502 to the IIoT device 504 may be referred to as downlink communication. The IIoT device 504 may receive the communication 508 and may take an action based on the command. Following the action, the IIoT device 504 may transmit a communication 510 back to the PLC 502 during a transmission time 512 (T_{D-UL}). There may be a first processing time 514 (T_{AP}) between receipt of the communication 506 from the PLC 502 and transmission of the communication 510 from the IIoT device 504. During the first processing time 514, the IIoT device 504 may be sensing, actuating, and/or the like.

In some aspects, the communication 510 may include sensed data from a sensor, a confirmation of actuation from an actuator, and/or the like. The communication 510 may include an application layer acknowledgement. The communication 510 transmitted from the IIoT device 504 to the PLC 502 may be referred to as uplink communication. Following the PLC's receipt of the communication 510 from the IIoT device 504, there may be a second processing time 516 (T_{AP}) during which the PLC 502 may process the received information and before the PLC 502 sends additional communications/commands to the IIoT device 504. The combined cycle may have a duration 518 of length T_{cycle}. Following the second processing time 516 (T_{AP}), the combined cycle may repeat with the PLC 502 sending a subsequent communication 506 to the IIoT device 504.

The IIoT communication network may accommodate periodic, regular traffic between PLCs 502 and an IIoT device 504. The communications between the PLC 502 and the IIoT device 504 may be associated with a low latency and high reliability. For example, the communications of the low latency may be less than 2 milliseconds (ms) or less than 1 ms. The high reliability may correspond to an error rate of 10⁻⁵ or less, 10⁻⁶ or less, and/or the like. The latency and reliability may apply to data and/or control channels.

In some aspects, a PLC 502 may use a control channel, such as a PDCCH, to grant resources to IIoT device 504 for use in transmitting the uplink communication 510. Factory automation may involve a high IIoT device 504 density (e.g., approximately 1 UE per m²). Therefore, a large number of IIoT devices 504 may communicate with the PLC 502. Sending a dynamic grant (e.g., one DCI in each slot) to each of the large number of IIoT devices 504 may place a burden on PDCCH overhead. SPS may be used to reduce the overhead requirements of PDCCH by enabling the IIoT devices 504 to be granted resources in a semi-persistent or periodic manner (e.g., without each granted resource being associated with an explicit scheduling grant). SPS may also be used to schedule resources for receiving downlink communication. SPS may be communicated to each IIoT device 504 using radio resource control (RRC) signaling, MAC-CE signaling, and/or DCI. In some aspects, SPS may be used for a first transmission, and PDCCH may be used to schedule a possible retransmission if the first transmission is not accurately received.

As indicated above, FIG. 5 is provided as an example. Other examples may differ from what is described with respect to FIG. 5.

In some cases, a CSI report may indicate one or more channel statistics associated with one or more channel measurement parameters (e.g., RSRP, interference, and/or signal-to-interference-plus-noise ratio (SINR)). The channel statistics may indicate information associated with the one or more channel measurement parameters over time (e.g., rather than reporting one or more values of the channel measurement parameters, the channel statistics may indicate information regarding the values of the channel measurement parameters over time). For example, the channel statistics may indicate a maximum value of a channel measurement parameter over a period of time, a minimum value of a channel measurement parameter over a period of time, a standard deviation of values of a channel measurement parameter over a period of time, a percentile of values of a channel measurement parameter over a period of time, among other examples.

A CSI report that indicates channel statistics may be referred to herein as a “channel statistics report”. A channel statistics report provides additional insight regarding a channel to a base station 110 (e.g., because a channel statistic indicates information regarding value of a channel measurement parameter over time), enabling the base station 110 to make improved decisions regarding selecting transmission parameters for downlink communications to the UE 120, such as a number of transmission layers (e.g., a rank), a precoding matrix (e.g., a precoder), an MCS, a refined downlink beam (e.g., using a beam refinement procedure or a beam management procedure), and/or cell coordination, among other examples. The base station 110 may utilize a channel statistics report to make improved long-term decisions for the UE 120 (or UEs 120 within a coverage area of the base station 110), such as MCS determinations, scheduling determinations, and/or beam management determinations, among other examples. For example, if a UE 120 transmits a channel statistics report that indicates consistently high interference levels (e.g., high SINR over time), the base station 110 may adjust a MCS for the UE 120 to account for the high interreference levels experienced by the UE 120. A CSI report that indicates only values associated with a channel measurement parameter (e.g., and not statistics), such as a single value of SINR, may not enable the base station 110 to determine that the UE 120 is experiencing the consistently high interference levels over time. As a result, the channel statistics report enables the base station 110 to make improved decisions for the UE 120.

In some wireless networks, such as a wireless network in which a traffic pattern is deterministic (e.g., an IIoT wireless network), channel measurement parameters may be predictable per communication instance. In other words, in a wireless network in which different cells transmit SPS communications, overlaps in resources used for the SPS communications (or interference caused by the SPS communications) may occur regularly. As a result, SINR per SPS occasion (e.g., per SPS transmission opportunity) may be predictable. Therefore, it may be beneficial for a UE 120 in such a wireless network to transmit channel statistics reports to a base station 110, to enable the base station 110 to make improved selections associated with transmission parameters for downlink communications to the UE 120. However, a channel statistics report may require dynamic grants (e.g., DCI) that schedule downlink communications that are to be the basis of the channel statistics report (e.g., that are to be measured to determine the channel statistics) and that indicate uplink resources for transmitting the channel statistics report. Therefore, a UE 120 may be unable to calculate and transmit channel statistics that are based at least in part on SPS communications.

Some techniques and apparatuses described herein enable semi-persistent transmission based channel statistics reporting. For example, a UE 120 may be configured with a time window for computing channel statistics based at least in part on measurements of SPS communications during the time window. The UE 120 may transmit the channel statistics report using uplink resources associated with ACK/NACK feedback of a most recent SPS communication or different uplink resources. In some aspects, the channel statistics report may be periodic or semi-persistent (e.g., a DCI may schedule multiple channel statistics reports to be transmitted at designated reporting times using indicated uplink resources), or aperiodic (e.g., triggered by DCI). As a result, a UE 120 may be enabled to calculate and transmit channel statistics that are based at least in part on SPS communications. Therefore, a base station 110 may be enabled to make improved selections associated with transmission parameters for downlink communications to the UE 120, thereby improving the performance (e.g., reliability, latency, and/or data rate) of communications between the UE 120 and the base station 110. Moreover, the channel statistics report enables the base station 110 to make improved determinations regarding a MCS for the UE 120, scheduling for the UE 120, and/or beam management for the UE 120, among other examples.

FIG. 6 is a diagram illustrating an example 600 associated with semi-persistent transmission based channel statistics reporting, in accordance with the present disclosure. As shown in FIG. 6, a base station 110 and a UE 120 may communicate with one another. In some aspects, the base station 110 and the UE 120 may be included in a wireless network, such as wireless network 100. In some aspects, the wireless network may be an IIoT wireless network. The base station 110 and the UE 120 may communicate on a wireless access link, which may include an uplink and a downlink.

As shown by reference number 605, the base station 110 may transmit, and the UE 120 may receive, a configuration indicating scheduling information for SPS communications between the base station 110 and the UE 120. The scheduling information for SPS communications may indicate a periodicity associated with the SPS communications. In some aspects, the scheduling information for SPS communications may indicate one or more SPS occasions (e.g., a time resource location and/or frequency resource location in which an SPS communication may be transmitted by the base station 110). In some aspects, the configuration may indicate one or more SPS configurations. For example, the configuration may indicate multiple SPS configurations, each SPS configuration associated with scheduling information as described above. In some aspects, the base station 110 may transmit the configuration using RRC signaling.

In some aspects, the configuration may indicate a channel statistics report configuration (e.g., indicating information associated with reporting channel statistics associated with the SPS communications). In some aspects, the channel statistics report configuration may be indicated by the base station 110 in a different communication (e.g., a different configuration and/or a different downlink control communication). The channel statistics report configuration may indicate one or more channel statistics to be reported by the UE 120, such as a maximum value of a channel measurement parameter, a minimum value of the channel measurement parameter, a standard deviation of values of the channel measurement parameter, and/or a percentile of values of the channel measurement parameter, among other examples. In some aspects, the channel statistics report configuration may indicate one or more channel measurement parameters for which the UE 120 is to compute the channel statistics, such as an RSRP of SPS communications, an interference level of SPS communications, an SINR of SPS communications, an RSSI of SPS communications, and/or a CQI of SPS communications, among other examples.

In some aspects, the channel statistics report configuration may indicate that the channel statistics reporting is to be per SPS configuration (e.g., the UE 120 is to transmit a separate channel statistics report for each SPS configuration). In some aspects, the channel statistics report configuration may indicate one or more (or all) SPS configurations for which the UE 120 is to compute channel statistics. In some aspects, the channel statistics report configuration may indicate that the UE 120 is to compute channel statistics across a set of SPS configurations and indicate the channel statistics in a single channel statistics report (e.g., the UE 120 is to perform measurements of SPS communications across the set of SPS configurations and compute channel statistics based at least in part on the measurements across the set of SPS configurations). In some aspects, the channel statistics report configuration may indicate one or more set of SPS configurations using RRC signaling. The base station 110 may update a set of SPS configurations using MAC-CE signaling or DCI signaling.

In some aspects, the channel statistics report configuration may indicate one or more time windows for the UE 120 to compute channel statistics, such as a time window 610 depicted in FIG. 6. The UE 120 may measure SPS communications during the time window and compute the channel statistics based at least in part on the measurements performed during the time window.

In some aspects, the channel statistics report configuration may indicate that the channel statistics report is a periodic channel statistics report or a semi-persistent channel statistics report. For example, the channel statistics report configuration may indicate a periodicity associated with transmitting a channel statistics report. In some aspects, the periodicity associated with transmitting a channel statistics report may be based at least in part on a duration of the time window 610. For example, the periodicity associated with transmitting a channel statistics report may be the same as the duration of the time window 610.

The channel statistics report configuration may indicate uplink resources (e.g., periodic uplink resources and/or semi-persistent uplink resources) to be used by the UE 120 for transmitting a channel statistics report. In some aspects, the channel statistics report configuration may indicate uplink resources in a similar manner as described above with respect to FIG. 3. For example, the channel statistics report configuration may indicate uplink resources that are the same as uplink resources that are to be used by the UE 120 for transmitting ACK/NACK feedback of an SPS communication. In some aspects, a configuration (e.g., the configuration indicating SPS scheduling information and/or the channel statistics report configuration) may indicate a first uplink resource for transmitting ACK/NACK feedback of an SPS communication and a second uplink resource (e.g., a different uplink resource) for transmitting a channel statistics report. The uplink resource for transmitting a channel statistics report may be an uplink control resource (e.g., a PUCCH resource) and/or an uplink data resource (e.g., a PUSCH resource).

In some aspects, where the channel statistics report is configured to be a semi-persistent channel statistics report, the base station 110 may transmit an activation and/or a deactivation of the channel statistics report. For example, the base station 110 may transmit a MAC-CE communication or a DCI communication indicating that the UE 120 is to transmit the channel statistics reports in accordance with the channel statistics report configuration (e.g., an activation message). The base station 110 may transmit a MAC-CE communication or a DCI communication indicating that the UE 120 is to stop transmitting the channel statistics reports (e.g., a deactivation message).

As shown by reference number 615, the base station 110 may transmit, and the UE 120 may receive, one or more SPS communications. The base station 110 may transmit the one or more SPS communications in accordance with a periodic schedule. The base station 110 may transmit the one or more SPS communications during one or more SPS occasions. In some aspects, an SPS communication in an SPS occasion may include multiple repetitions. The multiple repetitions may be in different time domain resources (e.g., the repetitions may be in different symbols), different frequency domain resources (e.g., the repetitions may be in different subbands), and/or different spatial domain resources (e.g., the repetitions may use different beams).

As shown by reference number 620, the UE 120 may determine one or more channel statistics associated with a channel measurement parameter based at least in part on the one or more semi-persistent communications. The UE 120 may determine the one or more channel statistics in accordance with the channel statistics report configuration. For example, the UE 120 may measure the one or more SPS communications to determine one or more values of the channel measurement parameter during the time window 610. The UE 120 may determine the one or more channel statistics based at least in part on the one or more values of the channel measurement parameter during the time window 610.

In some aspects, the UE 120 may measure an SPS communication based at least in part on measuring a DMRS associated with the SPS communication (e.g., a DMRS included in the SPS communication) to determine a value of the channel measurement parameter. In some aspects, the UE 120 may measure an SPS communication using decoded data (e.g., data symbols) associated with the SPS communication as a pilot for the measurement.

In some aspects, where an SPS occasion has multiple repetitions of an SPS transmission, the UE 120 may determine channel statistics per repetition of the SPS transmission (e.g., the UE 120 may determine channel statistics per repetition on a particular time domain resource (e.g., symbol), on a particular frequency domain resource (e.g., subband), and/or on a particular spatial domain resource (e.g., beam)).

In some aspects, where the channel statistics report is an aperiodic channel statistics report, the UE 120 may determine one or more channel statistics associated with a channel measurement parameter based at least in part on receiving DCI triggering the channel statistics report. The UE 120 may determine channel statistics based at least in part on measurements performed during a previous time window 610 before receiving the DCI. In some aspects, the UE 120 may determine channel statistics based at least in part on measurements performed prior to an end of a last SPS occasion before a reporting time indicated by the DCI. The DCI may indicate the reporting time and an uplink resource for transmitting the aperiodic channel statistics report. In some aspects, the DCI may indicate that the uplink resource is the same as an uplink resource to be used for transmitting ACK/NACK feedback of an SPS communication. In some aspects, the DCI may indicate that the uplink resource is a different uplink resource than the uplink resource to be used for transmitting ACK/NACK feedback of an SPS communication.

In some aspects, the UE 120 may determine one or more channel statistics across a set of SPS configurations, as described above. For example, the UE 120 may measure SPS communications across the set of SPS configurations. The UE 120 may determine one or more channel statistics based at least in part on the measurements of SPS communications across the set of SPS configurations. In some aspects, the UE 120 may determine separate channel statistics for one or more SPS configurations.

As shown by reference number 625, the UE 120 may transmit, and the base station 110 may receive, a channel statistics report. The channel statistics report may indicate the one or more channel statistics that are based at least in part on SPS communications. In some aspects, the UE 120 may transmit multiple channel statistics reports, or a channel statistics report may indicate multiple sets of channel statistics. For example, the UE 120 may indicate channel statistics associated with each SPS configuration, and/or associated with each repetition of an SPS occasion, among other examples.

The UE 120 may transmit the channel statistics report using an uplink resource indicated by the base station 110 (e.g., in a configuration, in the channel statistics reporting configuration, in an RRC communication, in a MAC-CE communication, and/or in a DCI communication). In some aspects, the UE 120 may transmit the channel statistics report using an uplink resource that also carries an ACK/NACK feedback message associated with an SPS communication. The UE 120 may transmit the channel statistics report at a reporting time indicated by the base station 110 (e.g., by a periodic schedule, in an activation message, and/or in DCI triggering the channel statistics report).

As a result, the UE 120 may be enabled to calculate and transmit channel statistics that are based at least in part on SPS communications. Therefore, the base station 110 may be enabled to make improved selections associated with transmission parameters for downlink communications to the UE 120, thereby improving the performance (e.g., reliability, latency, and/or data rate) of communications between the UE 120 and the base station 110. Moreover, the channel statistics report enables the base station 110 to make improved determinations regarding a MCS for the UE 120, scheduling for the UE 120, and/or beam management for the UE 120, among other examples.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with semi-persistent transmission based channel statistics reporting.

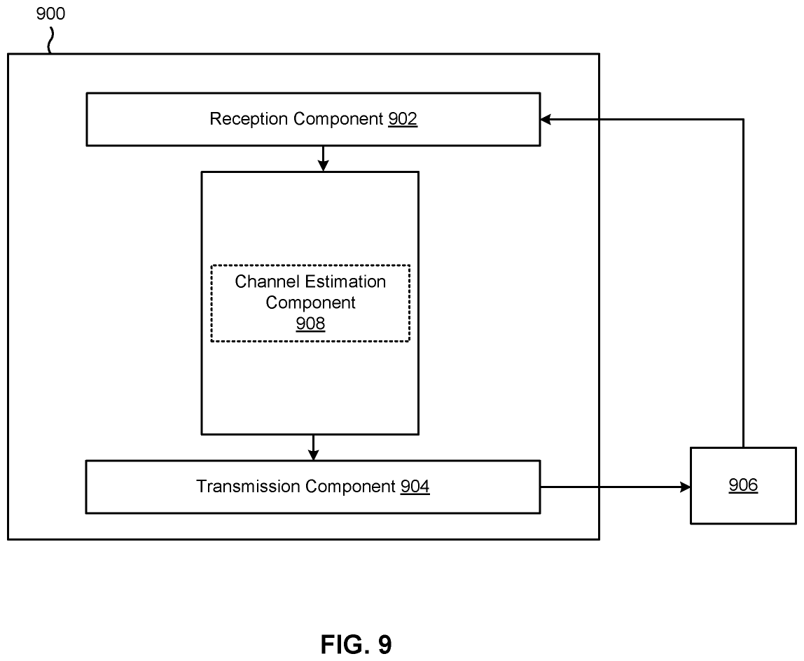

As shown in FIG. 7, in some aspects, process 700 may include receiving, from a base station, one or more semi-persistent communications (block 710). For example, the UE (e.g., using reception component 902, depicted in FIG. 9) may receive, from a base station, one or more semi-persistent communications, as described above.

As further shown in FIG. 7, in some aspects, process 700 may optionally include determining one or more channel statistics associated with a channel measurement parameter based at least in part on the one or more semi-persistent communications (block 720). For example, the UE (e.g., using channel estimation component 908, depicted in FIG. 9) may determine one or more channel statistics associated with a channel measurement parameter based at least in part on the one or more semi-persistent communications, as described above.

As further shown in FIG. 7, in some aspects, process 700 may include transmitting, to the base station, a channel statistics report indicating the one or more channel statistics associated with a channel measurement parameter based at least in part on the one or more semi-persistent communications (block 730). For example, the UE (e.g., using transmission component 904, depicted in FIG. 9) may transmit, to the base station, a channel statistics report indicating the one or more channel statistics associated with a channel measurement parameter based at least in part on the one or more semi-persistent communications, as described above.

Process 700 may include additional aspects, such as any single aspect or any combination of aspects described below and/or in connection with one or more other processes described elsewhere herein.

In a first aspect, the one or more channel statistics include at least one of a maximum value of the channel measurement parameter, a minimum value of the channel measurement parameter, a standard deviation of values of the channel measurement parameter, or a percentile of values of the channel measurement parameter.

In a second aspect, alone or in combination with the first aspect, the channel measurement parameter is at least one of a reference signal received power associated with the one or more semi-persistent communications, an interference level associated with the one or more semi-persistent communications, a signal to interference plus noise ratio associated with the one or more semi-persistent communications, a reference signal received quality associated with the one or more semi-persistent communications, a received signal strength indicator associated with the one or more semi-persistent communications, or a channel quality indicator associated with the one or more semi-persistent communications.

In a third aspect, alone or in combination with one or more of the first and second aspects, determining the one or more channel statistics associated with the channel measurement parameter comprises measuring the one or more semi-persistent communications to determine one or more values of the channel measurement parameter, wherein the one or more channel statistics are based at least in part on the one or more values of the channel measurement parameter.

In a fourth aspect, alone or in combination with one or more of the first through third aspects, measuring the one or more semi-persistent communications comprises measuring, for a semi-persistent communication of the one or more semi-persistent communications, a demodulation reference signal associated with the semi-persistent communication, to determine a value of the channel measurement parameter.

In a fifth aspect, alone or in combination with one or more of the first through fourth aspects, measuring the one or more semi-persistent communications comprises measuring a semi-persistent communication of the one or more semi-persistent communications using decoded data associated with the semi-persistent communication.

In a sixth aspect, alone or in combination with one or more of the first through fifth aspects, receiving the one or more semi-persistent communications comprises receiving, during a semi-persistent scheduling occasion, a plurality of repetitions of a semi-persistent communication of the one or more semi-persistent communications.

In a seventh aspect, alone or in combination with one or more of the first through sixth aspects, determining the one or more channel statistics associated with the channel measurement parameter comprises determining one or more channel statistics per repetition of the one or more semi-persistent communications.

In an eighth aspect, alone or in combination with one or more of the first through seventh aspects, receiving the plurality of repetitions of the semi-persistent communication comprises at least one of receiving the plurality of repetitions in different symbols, receiving the plurality of repetitions in different subbands, or receiving the plurality of repetitions on different beams.

In a ninth aspect, alone or in combination with one or more of the first through eighth aspects, transmitting the channel statistics report indicating the one or more channel statistics comprises at least one of transmitting, using a periodic uplink resource, the channel statistics report, transmitting, using a semi-persistent uplink resource, the channel statistics report, or transmitting, using an aperiodic uplink resource, the channel statistics report.

In a tenth aspect, alone or in combination with one or more of the first through ninth aspects, process 700 includes receiving, from the base station, a configuration associated with reporting channel statistics.

In an eleventh aspect, alone or in combination with one or more of the first through tenth aspects, the configuration indicates a time window for performing measurements of the one or more semi-persistent communications.

In a twelfth aspect, alone or in combination with one or more of the first through eleventh aspects, determining the one or more channel statistics associated with the channel measurement parameter comprises measuring, during the time window, the one or more semi-persistent communications to determine one or more values of the channel measurement parameter, wherein the one or more channel statistics are based at least in part on the one or more values of the channel measurement parameter.

In a thirteenth aspect, alone or in combination with one or more of the first through twelfth aspects, the channel statistics report is a periodic channel statistics report or a semi-persistent channel statistics report, and the configuration indicates a periodicity associated with a reporting time of the channel statistics report.

In a fourteenth aspect, alone or in combination with one or more of the first through thirteenth aspects, the periodicity associated with a reporting time of the channel statistics report is based at least in part on a time window for performing measurements of the one or more semi-persistent communications.

In a fifteenth aspect, alone or in combination with one or more of the first through fourteenth aspects, the configuration indicates an uplink resource to be used for transmitting the channel statistics report.

In a sixteenth aspect, alone or in combination with one or more of the first through fifteenth aspects, the uplink resource is an uplink resource associated with an acknowledgement or negative acknowledgement feedback message for a semi-persistent communication.

In a seventeenth aspect, alone or in combination with one or more of the first through sixteenth aspects, transmitting the channel statistics report indicating the one or more channel statistics comprises transmitting, to the base station at a reporting time, the channel statistics report using the uplink resource.

In an eighteenth aspect, alone or in combination with one or more of the first through seventeenth aspects, the channel statistics report is a semi-persistent channel statistics report, and process 700 includes receiving, from the base station via MAC-CE signaling or DCI signaling, an activation message or a deactivation message associated with the channel statistics report.

In a nineteenth aspect, alone or in combination with one or more of the first through eighteenth aspects, the channel statistics report is an aperiodic channel statistics report, and process 700 includes receiving DCI triggering the channel statistics report.

In a twentieth aspect, alone or in combination with one or more of the first through nineteenth aspects, the DCI indicates a reporting time associated with the channel statistics report.

In a twenty-first aspect, alone or in combination with one or more of the first through twentieth aspects, determining the one or more channel statistics associated with the channel measurement parameter comprises determining the one or more channel statistics associated with the channel measurement parameter based at least in part on one or more measurements performed during a previous time window, for performing measurements of the one or more semi-persistent communications, before the DCI is received.

In a twenty-second aspect, alone or in combination with one or more of the first through twenty-first aspects, determining the one or more channel statistics associated with the channel measurement parameter comprises determining one or more channel statistics associated with the channel measurement parameter based at least in part on one or more measurements performed before the end of a last semi-persistent scheduling occasion before a reporting time associated with transmitting the channel statistics report.

In a twenty-third aspect, alone or in combination with one or more of the first through twenty-second aspects, the DCI indicates an uplink resource to be used for transmitting the channel statistics report.

In a twenty-fourth aspect, alone or in combination with one or more of the first through twenty-third aspects, the uplink resource is an uplink resource associated with an acknowledgement or negative acknowledgement feedback message for a semi-persistent communication.

In a twenty-fifth aspect, alone or in combination with one or more of the first through twenty-fourth aspects, transmitting the channel statistics report indicating the one or more channel statistics comprises transmitting, to the base station at a reporting time, the channel statistics report using the uplink resource.

In a twenty-sixth aspect, alone or in combination with one or more of the first through twenty-fifth aspects, process 700 includes receiving a plurality of SPS configurations.

In a twenty-seventh aspect, alone or in combination with one or more of the first through twenty-sixth aspects, process 700 includes receiving a configuration associated with reporting channel statistics.

In a twenty-eighth aspect, alone or in combination with one or more of the first through twenty-seventh aspects, the configuration associated with reporting channel statistics is for all of the plurality of SPS configurations, a subset of SPS configurations of the plurality of SPS configurations, or an SPS configuration of the plurality of SPS configurations.

In a twenty-ninth aspect, alone or in combination with one or more of the first through twenty-eighth aspects, the configuration associated with reporting channel statistics is for all SPS configurations of the plurality of SPS configurations or a subset of SPS configurations of the plurality of SPS configurations, and transmitting the channel statistics report indicating the one or more channel statistics comprises transmitting channel statistics reports per SPS configuration.

In a thirtieth aspect, alone or in combination with one or more of the first through twenty-ninth aspects, the configuration associated with reporting channel statistics is for all SPS configurations of the plurality of SPS configurations or a subset of SPS configurations of the plurality of SPS configurations, and transmitting the channel statistics report indicating the one or more channel statistics comprises transmitting a channel statistics report indicating one or more channel statistics of semi-persistent communications across all SPS configurations or across the subset of SPS configurations.

In a thirty-first aspect, alone or in combination with one or more of the first through thirtieth aspects, the configuration associated with reporting channel statistics is received via radio resource control signaling, and process 700 includes receiving, via MAC-CE signaling or DCI signaling, an update to the configuration associated with reporting channel statistics.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with semi-persistent transmission based channel statistics reporting.

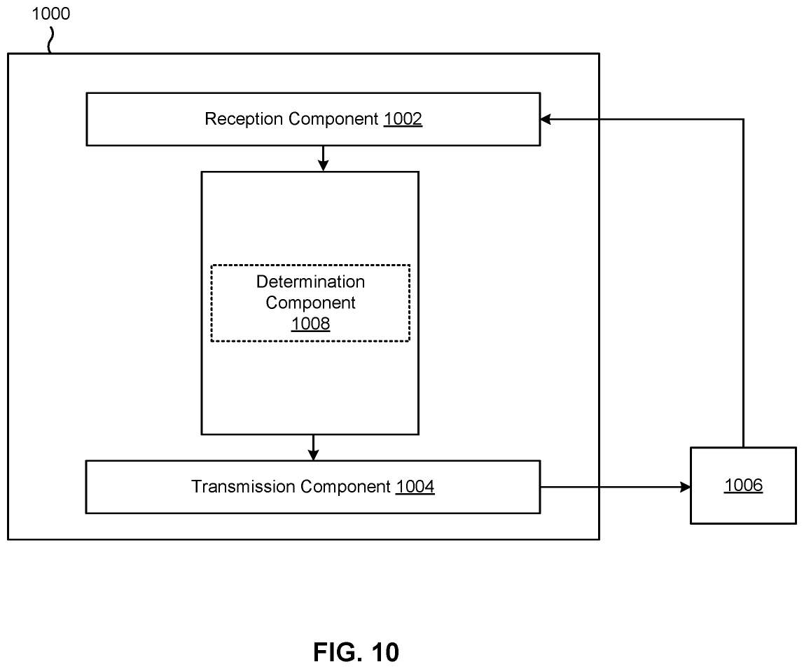

As shown in FIG. 8, in some aspects, process 800 may include transmitting, to a UE, one or more semi-persistent communications (block 810). For example, the base station (e.g., using transmission component 1004, depicted in FIG. 10) may transmit, to a UE, one or more semi-persistent communications, as described above.

As further shown in FIG. 8, in some aspects, process 800 may include receiving, from the UE, a channel statistics report indicating one or more channel statistics that are based at least in part on a channel measurement parameter associated with the one or more semi-persistent communications (block 820). For example, the base station (e.g., using reception component 1002, depicted in FIG. 10) may receive, from the UE, a channel statistics report indicating one or more channel statistics that are based at least in part on a channel measurement parameter associated with the one or more semi-persistent communications, as described above.

Process 800 may include additional aspects, such as any single aspect or any combination of aspects described below and/or in connection with one or more other processes described elsewhere herein.

In a first aspect, the one or more channel statistics include at least one of a maximum value of the channel measurement parameter, a minimum value of the channel measurement parameter, a standard deviation of values of the channel measurement parameter, or a percentile of values of the channel measurement parameter.

In a second aspect, alone or in combination with the first aspect, the channel measurement parameter is at least one of a reference signal received power associated with the one or more semi-persistent communications, an interference level associated with the one or more semi-persistent communications, a signal to interference plus noise ratio associated with the one or more semi-persistent communications, a reference signal received quality associated with the one or more semi-persistent communications, a received signal strength indicator associated with the one or more semi-persistent communications, or a channel quality indicator associated with the one or more semi-persistent communications.

In a third aspect, alone or in combination with one or more of the first and second aspects, transmitting the one or more semi-persistent communications comprises transmitting, during a semi-persistent scheduling occasion, a plurality of repetitions of a semi-persistent communication of the one or more semi-persistent communications.

In a fourth aspect, alone or in combination with one or more of the first through third aspects, receiving the channel statistics report indicating the one or more channel statistics comprises receiving channel statistics reports per repetition of the one or more semi-persistent communications.

In a fifth aspect, alone or in combination with one or more of the first through fourth aspects, transmitting the plurality of repetitions of the semi-persistent communication comprises at least one of transmitting the plurality of repetitions in different symbols, transmitting the plurality of repetitions in different subbands, or transmitting the plurality of repetitions on different beams.

In a sixth aspect, alone or in combination with one or more of the first through fifth aspects, receiving the channel statistics report indicating the one or more channel statistics comprises at least one of receiving, in a periodic uplink resource, the channel statistics report, receiving, in a semi-persistent uplink resource, the channel statistics report, or receiving, in an aperiodic uplink resource, the channel statistics report.

In a seventh aspect, alone or in combination with one or more of the first through sixth aspects, process 800 includes transmitting, to the UE, a configuration associated with reporting channel statistics.

In an eighth aspect, alone or in combination with one or more of the first through seventh aspects, the configuration indicates a time window for the UE to perform measurements of the one or more semi-persistent communications.

In a ninth aspect, alone or in combination with one or more of the first through eighth aspects, the channel statistics report is a periodic channel statistics report or a semi-persistent channel statistics report, and the configuration indicates a periodicity associated with a reporting time of the channel statistics report.

In a tenth aspect, alone or in combination with one or more of the first through ninth aspects, the periodicity associated with a reporting time of the channel statistics report is based at least in part on a time window for performing measurements of the one or more semi-persistent communications.

In an eleventh aspect, alone or in combination with one or more of the first through tenth aspects, the configuration indicates an uplink resource to be used by the UE for transmitting the channel statistics report.

In a twelfth aspect, alone or in combination with one or more of the first through eleventh aspects, the uplink resource is an uplink resource associated with an acknowledgement or negative acknowledgement feedback message for a semi-persistent communication.

In a thirteenth aspect, alone or in combination with one or more of the first through twelfth aspects, receiving the channel statistics report indicating the one or more channel statistics comprises receiving, from the UE at a reporting time, the channel statistics report in the uplink resource.

In a fourteenth aspect, alone or in combination with one or more of the first through thirteenth aspects, the channel statistics report is a semi-persistent channel statistics report, and process 800 includes transmitting, to the UE via MAC-CE signaling or DCI signaling, an activation message or deactivation message associated with the channel statistics report.

In a fifteenth aspect, alone or in combination with one or more of the first through fourteenth aspects, the channel statistics report is an aperiodic channel statistics report, and process 800 includes transmitting, to the UE, DCI triggering the channel statistics report.

In a sixteenth aspect, alone or in combination with one or more of the first through fifteenth aspects, the DCI indicates a reporting time associated with the channel statistics report.

In a seventeenth aspect, alone or in combination with one or more of the first through sixteenth aspects, the DCI indicates an uplink resource to be used by the UE for transmitting the channel statistics report.

In an eighteenth aspect, alone or in combination with one or more of the first through seventeenth aspects, the uplink resource is an uplink resource associated with an acknowledgement or negative acknowledgement feedback message for a semi-persistent communication.

In a nineteenth aspect, alone or in combination with one or more of the first through eighteenth aspects, receiving the channel statistics report indicating the one or more channel statistics comprises receiving, from the UE at a reporting time, the channel statistics report in the uplink resource.

In a twentieth aspect, alone or in combination with one or more of the first through nineteenth aspects, process 800 includes transmitting, to the UE, a plurality of SPS configurations.

In a twenty-first aspect, alone or in combination with one or more of the first through twentieth aspects, process 800 includes transmitting, to the UE, a configuration associated with reporting channel statistics.

In a twenty-second aspect, alone or in combination with one or more of the first through twenty-first aspects, the configuration associated with reporting channel statistics is for all SPS configurations of the plurality of SPS configurations, a subset of SPS configurations of the plurality of SPS configurations, or an SPS configuration of the plurality of SPS configurations.

In a twenty-third aspect, alone or in combination with one or more of the first through twenty-second aspects, the configuration associated with reporting channel statistics is for all SPS configurations of the plurality of SPS configurations or a subset of SPS configurations of the plurality of SPS configurations, and receiving the channel statistics report indicating the one or more channel statistics comprises receiving channel statistics reports per SPS configuration.

In a twenty-fourth aspect, alone or in combination with one or more of the first through twenty-third aspects, the configuration associated with reporting channel statistics is for all SPS configurations of the plurality of SPS configurations or a subset of SPS configurations of the plurality of SPS configurations, and receiving the channel statistics report indicating the one or more channel statistics comprises receiving a channel statistics report indicating one or more channel statistics of semi-persistent communications across all SPS configurations or across the subset of SPS configurations.

In a twenty-fifth aspect, alone or in combination with one or more of the first through twenty-fourth aspects, the configuration associated with reporting channel statistics is transmitted via radio resource control signaling, and process 800 includes transmitting, via MAC-CE signaling or DCI signaling, an update to the configuration associated with reporting channel statistics.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a channel estimation component 908, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be collocated with the reception component 902 in a transceiver.

The reception component 902 may receive, from a base station, one or more semi-persistent communications. The channel estimation component 908 may determine one or more channel statistics associated with a channel measurement parameter based at least in part on the one or more semi-persistent communications. In some aspects, the channel estimation component 908 may include one or more antennas, a demodulator, a receive processor, a transmit MIMO processor, a transmit processor, a controller/processor, a memory, or a combination thereof, of the UE described above in connection with FIG. 2. The transmission component 904 may transmit, to the base station, a channel statistics report indicating the one or more channel statistics associated with a channel measurement parameter based at least in part on the one or more semi-persistent communications.

The channel estimation component 908 may measure the one or more semi-persistent communications to determine one or more values of the channel measurement parameter. The channel estimation component 908 may determine the one or more channel statistics based at least in part on the one or more values of the channel measurement parameter. The channel estimation component 908 may measure, for a semi-persistent communication of the one or more semi-persistent communications, a DMRS associated with the semi-persistent communication, to determine a value of the channel measurement parameter. The channel estimation component 908 may measure a semi-persistent communication of the one or more semi-persistent communications using decoded data associated with the semi-persistent communication.

The reception component 902 may receive, during an SPS occasion, a plurality of repetitions of a semi-persistent communication one or more semi-persistent communications. The channel estimation component 908 may determine one or more channel statistics per repetition of the one or more semi-persistent communications. The reception component 902 may receive the plurality of repetitions in different symbols, may receive the plurality of repetitions in different subbands, or may receive the plurality of repetitions on different beams.

The transmission component 904 may transmit, using a periodic uplink resource, the channel statistics report, may transmit, using a semi-persistent uplink resource, the channel statistics report, or may transmit, using an aperiodic uplink resource, the channel statistics report.

The reception component 902 may receive, from the base station, a configuration associated with reporting channel statistics.

The channel estimation component 908 may measure, during a time window, the one or more semi-persistent communications to determine one or more values of the channel measurement parameter. The channel estimation component 908 may determine the one or more channel statistics based at least in part on the one or more values of the channel measurement parameter. The transmission component 904 may transmit, to the base station at a reporting time, the channel statistics report using the uplink resource.

The reception component 902 may receive, from the base station via MAC-CE signaling or DCI signaling, an activation message or a deactivation message associated with the channel statistics report. The reception component 902 may receive DCI triggering the channel statistics report.

The channel estimation component 908 may determine the one or more channel statistics associated with the channel measurement parameter based at least in part on one or more measurements performed during a previous time window, for performing measurements of the one or more semi-persistent communications, before the DCI is received.

The channel estimation component 908 may determine one or more channel statistics associated with the channel measurement parameter based at least in part on one or more measurements performed before the end of a last semi-persistent scheduling occasion before a reporting time associated with transmitting the channel statistics report.

The transmission component 904 may transmit, to the base station at a reporting time, the channel statistics report using the uplink resource. The reception component 902 may receive a plurality of SPS configurations. The reception component 902 may receive a configuration associated with reporting channel statistics.

The transmission component 904 may transmit channel statistics reports per SPS configuration. The transmission component 904 may transmit a channel statistics report indicating one or more channel statistics of semi-persistent communications across all SPS configurations or across the subset of SPS configurations. The reception component 902 may receive, via MAC-CE signaling or DCI signaling, an update to the configuration associated with reporting channel statistics.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a determination component 1008, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described above in connection with FIG. 2. In some aspects, the transmission component 1004 may be collocated with the reception component 1002 in a transceiver.

The transmission component 1004 may transmit, to a UE, one or more semi-persistent communications. The reception component 1002 may receive, from the UE, a channel statistics report indicating one or more channel statistics that are based at least in part on a channel measurement parameter associated with the one or more semi-persistent communications. The determination component 1008 may determine a configuration associated with reporting channel statistics. The determination component 1008 may determine one or more SPS configurations. In some aspects, the determination component may include a receive processor, a transmit MIMO processor, a transmit processor, a controller/processor, a memory, or a combination thereof, of the base station described above in connection with FIG. 2.

The transmission component 1004 may transmit, during an SPS occasion, a plurality of repetitions of a semi-persistent communication. The reception component 1002 may receive channel statistics reports per repetition of the semi-persistent communication. The transmission component 1004 may transmit the plurality of repetitions in different symbols, may transmit the plurality of repetitions in different subbands, or may transmit the plurality of repetitions on different beams.

The reception component 1002 may receive, in a periodic uplink resource, the channel statistics report, may receive, in a semi-persistent uplink resource, the channel statistics report, or may receive, in an aperiodic uplink resource, the channel statistics report.

The transmission component 1004 may transmit, to the UE, a configuration associated with reporting channel statistics. The reception component 1002 may receive, from the UE at a reporting time, the channel statistics report in the uplink resource.

The transmission component 1004 may transmit, to the UE via MAC-CE signaling or DCI signaling, an activation message or deactivation message associated with the channel statistics report. The transmission component 1004 may transmit, to the UE, DCI triggering the channel statistics report.

The reception component 1002 may receive, from the UE at a reporting time, the channel statistics report in the uplink resource. The transmission component 1004 may transmit, to the UE, a plurality of SPS configurations. The transmission component 1004 may transmit, to the UE, a configuration associated with reporting channel statistics. The reception component 1002 may receive channel statistics reports per SPS configuration.

The reception component 1002 may receive a channel statistics report indicating one or more channel statistics of semi-persistent communications across all SPS configurations or across the subset of SPS configurations. The transmission component 1004 may transmit, via MAC-CE signaling or DCI signaling, an update to the configuration associated with reporting channel statistics.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving, from a base station, one or more semi-persistent communications; and transmitting, to the base station, a channel statistics report indicating one or more channel statistics associated with a channel measurement parameter based at least in part on the one or more semi-persistent communications.
Aspect 2: The method of Aspect 1, wherein the one or more channel statistics include at least one of: a maximum value of the channel measurement parameter, a minimum value of the channel measurement parameter, a standard deviation of values of the channel measurement parameter, or a percentile of values of the channel measurement parameter.
Aspect 3: The method of any of Aspects 1-2, wherein the channel measurement parameter is at least one of: a reference signal received power associated with the one or more semi-persistent communications, an interference level associated with the one or more semi-persistent communications, a signal to interference plus noise ratio associated with the one or more semi-persistent communications, a reference signal received quality associated with the one or more semi-persistent communications, a received signal strength indicator associated with the one or more semi-persistent communications, or a channel quality indicator associated with the one or more semi-persistent communications.
Aspect 4: The method of any of Aspects 1-3, further comprising: measuring the one or more semi-persistent communications to determine one or more values of the channel measurement parameter, wherein the one or more channel statistics are based at least in part on the one or more values of the channel measurement parameter.
Aspect 5: The method of Aspect 4, wherein measuring the one or more semi-persistent communications comprises: measuring, for a semi-persistent communication of the one or more semi-persistent communications, a demodulation reference signal associated with the semi-persistent communication, to determine a value of the channel measurement parameter.
Aspect 6: The method of any of Aspects 4-5, wherein measuring the one or more semi-persistent communications comprises: measuring a semi-persistent communication of the one or more semi-persistent communications using decoded data associated with the semi-persistent communication.
Aspect 7: The method of any of Aspects 1-6, wherein receiving the one or more semi-persistent communications comprises: receiving, during a semi-persistent scheduling occasion, a plurality of repetitions of a semi-persistent communication one or more semi-persistent communications.
Aspect 8: The method of Aspect 7, further comprising: determining one or more channel statistics per repetition of the one or more semi-persistent communications.
Aspect 9: The method of any of Aspects 7-8, wherein receiving the plurality of repetitions of the semi-persistent communication comprises at least one of: receiving the plurality of repetitions in different symbols, receiving the plurality of repetitions in different subbands, or receiving the plurality of repetitions on different beams.
Aspect 10: The method of any of Aspects 1-9, wherein transmitting the channel statistics report indicating the one or more channel statistics comprises at least one of: transmitting, using a periodic uplink resource, the channel statistics report, transmitting, using a semi-persistent uplink resource, the channel statistics report, or transmitting, using an aperiodic uplink resource, the channel statistics report.
Aspect 11: The method of any of Aspects 1-10, further comprising: receiving, from the base station, a configuration associated with reporting channel statistics.
Aspect 12: The method of Aspect 11, wherein the configuration indicates a time window for performing measurements of the one or more semi-persistent communications.
Aspect 13: The method of Aspect 12, wherein further comprising: measuring, during the time window, the one or more semi-persistent communications to determine one or more values of the channel measurement parameter, wherein the one or more channel statistics are based at least in part on the one or more values of the channel measurement parameter.
Aspect 14: The method of any of Aspects 11-13, wherein the channel statistics report is a periodic channel statistics report or a semi-persistent channel statistics report, and the configuration indicates a periodicity associated with a reporting time of the channel statistics report.
Aspect 15: The method of Aspect 14, wherein the periodicity associated with a reporting time of the channel statistics report is based at least in part on a time window for performing measurements of the one or more semi-persistent communications.
Aspect 16: The method of any of Aspects 14-15, wherein the configuration indicates an uplink resource to be used for transmitting the channel statistics report.
Aspect 17: The method of Aspect 16, wherein the uplink resource is an uplink resource associated with an acknowledgement or negative acknowledgement feedback message for a semi-persistent communication.
Aspect 18: The method of any of Aspects 16-17, wherein transmitting the channel statistics report indicating the one or more channel statistics comprises: transmitting, to the base station at a reporting time, the channel statistics report using the uplink resource.
Aspect 19: The method of any of Aspects 1-18, wherein the channel statistics report is a semi-persistent channel statistics report, the method further comprising: receiving, from the base station via medium access control (MAC) control element (MAC-CE) signaling or downlink control information signaling, an activation message or a deactivation message associated with the channel statistics report.
Aspect 20: The method of any of Aspects 1-19, wherein the channel statistics report is an aperiodic channel statistics report, the method further comprising: receiving downlink control information (DCI) triggering the channel statistics report.
Aspect 21: The method of Aspect 20, wherein the DCI indicates a reporting time associated with the channel statistics report.
Aspect 22: The method of any of Aspects 20-21, further comprising: determining the one or more channel statistics associated with the channel measurement parameter based at least in part on one or more measurements performed during a previous time window, for performing measurements of the one or more semi-persistent communications, before the DCI is received.
Aspect 23: The method of any of Aspects 20-22, further comprising: determining one or more channel statistics associated with the channel measurement parameter based at least in part on one or more measurements performed before the end of a last semi-persistent scheduling occasion before a reporting time associated with transmitting the channel statistics report.
Aspect 24: The method of any of Aspects 20-23, wherein the DCI indicates an uplink resource to be used for transmitting the channel statistics report.
Aspect 25: The method of Aspect 24, wherein the uplink resource is an uplink resource associated with an acknowledgement or negative acknowledgement feedback message for a semi-persistent communication.
Aspect 26: The method of any of Aspects 24-25, wherein transmitting the channel statistics report indicating the one or more channel statistics comprises: transmitting, to the base station at a reporting time, the channel statistics report using the uplink resource.
Aspect 27: The method of any of Aspects 1-26, further comprising: receiving a plurality of semi-persistent scheduling (SPS) configurations.
Aspect 28: The method of Aspect 27, further comprising: receiving a configuration associated with reporting channel statistics.
Aspect 29: The method of Aspect 28, wherein the configuration associated with reporting channel statistics is for all of the plurality of SPS configurations, a subset of SPS configurations of the plurality of SPS configurations, or an SPS configuration of the plurality of SPS configurations.
Aspect 30: The method of any of Aspects 28-29, wherein the configuration associated with reporting channel statistics is for all SPS configurations of the plurality of SPS configurations or a subset of SPS configurations of the plurality of SPS configurations, and wherein transmitting the channel statistics report indicating the one or more channel statistics comprises: transmitting channel statistics reports per SPS configuration.
Aspect 31: The method of any of Aspects 28-30, wherein the configuration associated with reporting channel statistics is for all SPS configurations of the plurality of SPS configurations or a subset of SPS configurations of the plurality of SPS configurations, and wherein transmitting the channel statistics report indicating the one or more channel statistics comprises: transmitting a channel statistics report indicating one or more channel statistics of semi-persistent communications across all SPS configurations or across the subset of SPS configurations.
Aspect 32: The method of any of Aspects 28-31, wherein the configuration associated with reporting channel statistics is received via radio resource control signaling, the method further comprising: receiving, via medium access control (MAC) control element (MAC-CE) signaling or downlink control information signaling, an update to the configuration associated with reporting channel statistics.
Aspect 33: A method of wireless communication performed by a base station, comprising: transmitting, to a user equipment (UE), one or more semi-persistent communications; and receiving, from the UE, a channel statistics report indicating one or more channel statistics that are based at least in part on a channel measurement parameter associated with the one or more semi-persistent communications.
Aspect 34: The method of Aspect 33, wherein the one or more channel statistics include at least one of: a maximum value of the channel measurement parameter, a minimum value of the channel measurement parameter, a standard deviation of values of the channel measurement parameter, or a percentile of values of the channel measurement parameter.
Aspect 35: The method of any of Aspects 33-34, wherein the channel measurement parameter is at least one of: a reference signal received power associated with the one or more semi-persistent communications, an interference level associated with the one or more semi-persistent communications, a signal to interference plus noise ratio associated with the one or more semi-persistent communications, a reference signal received quality associated with the one or more semi-persistent communications, a received signal strength indicator associated with the one or more semi-persistent communications, or a channel quality indicator associated with the one or more semi-persistent communications.
Aspect 36: The method of any of Aspects 33-35, wherein transmitting the one or more semi-persistent communications comprises: transmitting, during a semi-persistent scheduling occasion, a plurality of repetitions of a semi-persistent communication one or more semi-persistent communications.
Aspect 37: The method of Aspect 36, wherein receiving the channel statistics report indicating the one or more channel statistics comprises: receiving channel statistics reports per repetition of the one or more semi-persistent communications.
Aspect 38: The method of any of Aspects 36-37, wherein transmitting the plurality of repetitions of the semi-persistent communication comprises at least one of: transmitting the plurality of repetitions in different symbols, transmitting the plurality of repetitions in different subbands, or transmitting the plurality of repetitions on different beams.
Aspect 39: The method of any of Aspects 33-38, wherein receiving the channel statistics report indicating the one or more channel statistics comprises at least one of: receiving, in a periodic uplink resource, the channel statistics report, receiving, in a semi-persistent uplink resource, the channel statistics report, or receiving, in an aperiodic uplink resource, the channel statistics report.
Aspect 40: The method of any of Aspects 33-39, further comprising: transmitting, to the UE, a configuration associated with reporting channel statistics.
Aspect 41: The method of Aspect 40, wherein the configuration indicates a time window for the UE to perform measurements of the one or more semi-persistent communications.
Aspect 42: The method of any of Aspects 40-41, wherein the channel statistics report is a periodic channel statistics report or a semi-persistent channel statistics report, and the configuration indicates a periodicity associated with a reporting time of the channel statistics report.
Aspect 43: The method of Aspect 42, wherein the periodicity associated with a reporting time of the channel statistics report is based at least in part on a time window for performing measurements of the one or more semi-persistent communications.
Aspect 44: The method of any of Aspects 42-43, wherein the configuration indicates an uplink resource to be used by the UE for transmitting the channel statistics report.
Aspect 45: The method of Aspect 44, wherein the uplink resource is an uplink resource associated with an acknowledgement or negative acknowledgement feedback message for a semi-persistent communication.
Aspect 46: The method of any of Aspects 44-45, wherein receiving the channel statistics report indicating the one or more channel statistics comprises: receiving, from the UE at a reporting time, the channel statistics report in the uplink resource.
Aspect 47: The method of any of Aspects 33-46, wherein the channel statistics report is a semi-persistent channel statistics report, the method further comprising: transmitting, to the UE via medium access control (MAC) control element (MAC-CE) signaling or downlink control information signaling, an activation message or deactivation message associated with the channel statistics report.
Aspect 48: The method of any of Aspects 33-47, wherein the channel statistics report is an aperiodic channel statistics report, the method further comprising: transmitting, to the UE, downlink control information (DCI) triggering the channel statistics report.
Aspect 49: The method of Aspect 48, wherein the DCI indicates a reporting time associated with the channel statistics report.
Aspect 50: The method of any of Aspects 48-49, wherein the DCI indicates an uplink resource to be used by the UE for transmitting the channel statistics report.
Aspect 51: The method of Aspect 50, wherein the uplink resource is an uplink resource associated with an acknowledgement or negative acknowledgement feedback message for a semi-persistent communication.
Aspect 52: The method of any of Aspects 50-51, wherein receiving the channel statistics report indicating the one or more channel statistics comprises: receiving, from the UE at a reporting time, the channel statistics report in the uplink resource.
Aspect 53: The method of any of Aspects 33-52, further comprising: transmitting, to the UE, a plurality of semi-persistent scheduling (SPS) configurations.
Aspect 54: The method of Aspect 53, further comprising: transmitting, to the UE, a configuration associated with reporting channel statistics.
Aspect 55: The method of Aspect 54, wherein the configuration associated with reporting channel statistics is for all SPS configurations of the plurality of SPS configurations, a subset of SPS configurations of the plurality of SPS configurations, or an SPS configuration of the plurality of SPS configurations.
Aspect 56: The method of any of Aspects 54-55, wherein the configuration associated with reporting channel statistics is for all SPS configurations of the plurality of SPS configurations or a subset of SPS configurations of the plurality of SPS configurations, and wherein receiving the channel statistics report indicating the one or more channel statistics comprises: receiving channel statistics reports per SPS configuration.
Aspect 57: The method of any of Aspects 54-56, wherein the configuration associated with reporting channel statistics is for all SPS configurations of the plurality of SPS configurations or a subset of SPS configurations of the plurality of SPS configurations, and wherein receiving the channel statistics report indicating the one or more channel statistics comprises: receiving a channel statistics report indicating one or more channel statistics of semi-persistent communications across all SPS configurations or across the subset of SPS configurations.
Aspect 58: The method of any of Aspects 54-57, wherein the configuration associated with reporting channel statistics is transmitted via radio resource control signaling, the method further comprising: transmitting, via medium access control (MAC) control element (MAC-CE) signaling or downlink control information signaling, an update to the configuration associated with reporting channel statistics.
Aspect 59: An apparatus for wireless communication at a device, comprising a processor; memory coupled with the processor; and instructions stored in the memory and executable by the processor to cause the apparatus to perform the method of one or more of Aspects 1-32.
Aspect 60: A device for wireless communication, comprising a memory and one or more processors coupled to the memory, the one or more processors configured to perform the method of one or more of Aspects 1-32.
Aspect 61: An apparatus for wireless communication, comprising at least one means for performing the method of one or more of Aspects 1-32.
Aspect 62: A non-transitory computer-readable medium storing code for wireless communication, the code comprising instructions executable by a processor to perform the method of one or more of Aspects 1-32.
Aspect 63: A non-transitory computer-readable medium storing a set of instructions for wireless communication, the set of instructions comprising one or more instructions that, when executed by one or more processors of a device, cause the device to perform the method of one or more of Aspects 1-32.
Aspect 64: An apparatus for wireless communication at a device, comprising a processor; memory coupled with the processor; and instructions stored in the memory and executable by the processor to cause the apparatus to perform the method of one or more of Aspects 33-58.
Aspect 65: A device for wireless communication, comprising a memory and one or more processors coupled to the memory, the one or more processors configured to perform the method of one or more of Aspects 33-58.
Aspect 66: An apparatus for wireless communication, comprising at least one means for performing the method of one or more of Aspects 33-58.
Aspect 67: A non-transitory computer-readable medium storing code for wireless communication, the code comprising instructions executable by a processor to perform the method of one or more of Aspects 33-58.
Aspect 68: A non-transitory computer-readable medium storing a set of instructions for wireless communication, the set of instructions comprising one or more instructions that, when executed by one or more processors of a device, cause the device to perform the method of one or more of Aspects 33-58.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, one or more semi-persistent communications; and
transmitting, to the base station, a channel statistics report indicating one or more channel statistics associated with a channel measurement parameter based at least in part on the one or more semi-persistent communications.

2. The method of claim 1, wherein the one or more channel statistics include at least one of:
a maximum value of the channel measurement parameter,
a minimum value of the channel measurement parameter,
a standard deviation of values of the channel measurement parameter, or
a percentile of values of the channel measurement parameter.

3. The method of claim 1, wherein the channel measurement parameter is at least one of:
a reference signal received power associated with the one or more semi-persistent communications,
an interference level associated with the one or more semi-persistent communications,
a signal to interference plus noise ratio associated with the one or more semi-persistent communications,
a reference signal received quality associated with the one or more semi-persistent communications,
a received signal strength indicator associated with the one or more semi-persistent communications, or
a channel quality indicator associated with the one or more semi-persistent communications.

4. The method of claim 1, further comprising:
measuring the one or more semi-persistent communications to determine one or more values of the channel measurement parameter, wherein the one or more channel statistics are based at least in part on the one or more values of the channel measurement parameter.

5. The method of claim 1, wherein transmitting the channel statistics report indicating the one or more channel statistics comprises at least one of:
transmitting, using a periodic uplink resource, the channel statistics report,
transmitting, using a semi-persistent uplink resource, the channel statistics report, or
transmitting, using an aperiodic uplink resource, the channel statistics report.

6. The method of claim 1, further comprising:
receiving, from the base station, a configuration associated with reporting channel statistics.

7. The method of claim 6, wherein the configuration indicates a time window for performing measurements of the one or more semi-persistent communications.

8. The method of claim 1, wherein the channel statistics report is a semi-persistent channel statistics report, the method further comprising:
receiving, from the base station via medium access control (MAC) control element (MAC-CE) signaling or downlink control information signaling, an activation message or a deactivation message associated with the channel statistics report.

9. The method of claim 1, wherein the channel statistics report is an aperiodic channel statistics report, the method further comprising:
receiving downlink control information (DCI) triggering the channel statistics report.

10. A method of wireless communication performed by a base station, comprising:
transmitting, to a user equipment (UE), one or more semi-persistent communications; and
receiving, from the UE, a channel statistics report indicating one or more channel statistics that are based at least in part on a channel measurement parameter associated with the one or more semi-persistent communications.

11. The method of claim 10, wherein transmitting the one or more semi-persistent communications comprises:
transmitting, during a semi-persistent scheduling occasion, a plurality of repetitions of a semi-persistent communication of the one or more semi-persistent communications.

12. The method of claim 11, wherein receiving the channel statistics report indicating the one or more channel statistics comprises:
receiving channel statistics reports per repetition of the one or more semi-persistent communications.

13. The method of claim 10, further comprising:
transmitting, to the UE, a configuration associated with reporting channel statistics.

14. The method of claim 10, wherein the channel statistics report is a semi-persistent channel statistics report, the method further comprising:
transmitting, to the UE via medium access control (MAC) control element (MAC-CE) signaling or downlink control information signaling, an activation message or deactivation message associated with the channel statistics report.

15. The method of claim 10, wherein the channel statistics report is an aperiodic channel statistics report, the method further comprising:
transmitting, to the UE, downlink control information (DCI) triggering the channel statistics report.

16. A user equipment (UE) for wireless communication, comprising:
a memory; and
one or more processors, coupled to the memory, configured to:
receive, from a base station, one or more semi-persistent communications; and
transmit, to the base station, a channel statistics report indicating one or more channel statistics associated with a channel measurement parameter based at least in part on the one or more semi-persistent communications.

17. The UE of claim 16, wherein the one or more channel statistics include at least one of:
a maximum value of the channel measurement parameter,
a minimum value of the channel measurement parameter,
a standard deviation of values of the channel measurement parameter, or
a percentile of values of the channel measurement parameter.

18. The UE of claim 16, wherein the channel measurement parameter is at least one of:
a reference signal received power associated with the one or more semi-persistent communications,
an interference level associated with the one or more semi-persistent communications,
a signal to interference plus noise ratio associated with the one or more semi-persistent communications,
a reference signal received quality associated with the one or more semi-persistent communications,
a received signal strength indicator associated with the one or more semi-persistent communications, or
a channel quality indicator associated with the one or more semi-persistent communications.

19. The UE of claim 16, wherein the one or more processors are further configured to:
measure the one or more semi-persistent communications to determine one or more values of the channel measurement parameter, wherein the one or more channel statistics are based at least in part on the one or more values of the channel measurement parameter.

20. The UE of claim 16, wherein the one or more processors, to transmit the channel statistics report indicating the one or more channel statistics, are configured to:
transmit, using a periodic uplink resource, the channel statistics report,
transmit, using a semi-persistent uplink resource, the channel statistics report, or
transmit, using an aperiodic uplink resource, the channel statistics report.

21. The UE of claim 16, wherein the one or more processors are further configured to:
receive, from the base station, a configuration associated with reporting channel statistics.

22. The UE of claim 21, wherein the configuration indicates a time window for performing measurements of the one or more semi-persistent communications.

23. The UE of claim 16, wherein the channel statistics report is a semi-persistent channel statistics report, wherein the one or more processors are further configured to:
receive, from the base station via medium access control (MAC) control element (MAC-CE) signaling or downlink control information signaling, an activation message or a deactivation message associated with the channel statistics report.

24. The UE of claim 16, wherein the channel statistics report is an aperiodic channel statistics report, wherein the one or more processors are further configured to:
receive downlink control information (DCI) triggering the channel statistics report.

25. A base station for wireless communication, comprising:
a memory; and
one or more processors, coupled to the memory, configured to:
transmit, to a user equipment (UE), one or more semi-persistent communications; and
receive, from the UE, a channel statistics report indicating one or more channel statistics that are based at least in part on a channel measurement parameter associated with the one or more semi-persistent communications.

26. The base station of claim 25, wherein the one or more processors, to transmit the one or more semi-persistent communications, are configured to:
transmit, during a semi-persistent scheduling occasion, a plurality of repetitions of a semi-persistent communication of the one or more semi-persistent communications.

27. The base station of claim 26, wherein the one or more processors, to receive the channel statistics report indicating the one or more channel statistics, are configured to:
receive channel statistics reports per repetition of the one or more semi-persistent communications.

28. The base station of claim 25, wherein the one or more processors are further configured to:
transmit, to the UE, a configuration associated with reporting channel statistics.

29. The base station of claim 25, wherein the channel statistics report is a semi-persistent channel statistics report, wherein the one or more processors are further configured to:
transmit, to the UE via medium access control (MAC) control element (MAC-CE) signaling or downlink control information signaling, an activation message or deactivation message associated with the channel statistics report.

30. The base station of claim 25, wherein the channel statistics report is an aperiodic channel statistics report, wherein the one or more processors are further configured to:
transmit, to the UE, downlink control information (DCI) triggering the channel statistics report.
